(19) United States
(12) Patent Application Publication
(10) Pub. No.: US 2015/0381536 A1
(43) Pub. Date: Dec. 31, 2015

(54) METHOD AND SYSTEM FOR PROMPT VIDEO-DATA MESSAGE TRANSFER TO PERSONAL DEVICES

(71) Applicant: OBSHESTVO S OGRANICHENNOY OTVETSTVENNOSTYU "SINEZIS", Moscow (RU)

(72) Inventor: Nikolai Vadimovich PTITSYN, Moscow (RU)

(21) Appl. No.: 14/846,279

(22) Filed: Sep. 4, 2015

Related U.S. Application Data
(63) Continuation of application No. PCT/RU2013/001193, filed on Dec. 30, 2013.

(30) Foreign Application Priority Data
Mar. 7, 2013 (EA) 201300533

(51) Int. Cl. H04L 12/58; H04L 29/08; H04L 29/06; H04N 7/18

(52) U.S. Cl. CPC H04L 51/10; H04N 7/18; H04L 67/10; H04L 69/04; H04L 51/38

(57) ABSTRACT

Instant disclosure is directed to the processing and transmission of data, namely, to the fields of closed-circuit security television (CCTV), video surveillance, and video analytics. The invention ensures alarm notifications from the monitored facility to mobile devices. The invention can be used in safety and security, communications, transportation, retail, manufacture, sports, entertainment, housing and utility services and social infrastructure. More specifically, there is disclosed a method of transmitting a message from a first computer system to a second computer system, the method comprising: receiving at the first computer system an event and related data (video data and information on the video data), generating a message based on the event and the related data, which includes, at least, a link to the video data, sending the message from the first computer system to the second computer system, receiving the message on the second computer system, analyzing the message received, and, if the analysis of the message received shows the need to analyze the video data, downloading the video data using the link in the message.

### CROSS-REFERENCE

The present application claims convention priority to Eurasian Utility Patent Application No. 201300533, filed on Mar. 7, 2013, entitled [symbol] [symbol] [symbol] [symbol] [symbol] [symbol] . This application is incorporated by reference herein in its entirety. The present application is a continuation of International Patent Application no. PCT/RU2013/001193, filed on Dec. 30, 2013, entitled “METHOD AND SYSTEM FOR PROMPT VIDEO-DATA MESSAGE TRANSFER TO PERSONAL DEVICES”, the entirety of which is incorporated herein by reference.

### TECHNICAL FIELD

The invention relates to data processing, namely, closed-circuit security television (CCTV), video surveillance, and video analytics and, more specifically, the invention relates to method and system for transmitting a video data message.

### BACKGROUND

A video surveillance system generally comprises (a) one or more cameras; (b) one or more video servers (DVRs); (c) one or more user (operator) workstations; and (d) a transmission network or other video channels. Components (a) are normally placed at the facility monitored, for example, in the monitored building or premises. Components (b), (c) and (d) can be placed both at the facility monitored and elsewhere.

A “video server” is a computer or other computing device that processes (performs video analysis, indexing, coding, transcoding), transmits and/or stores (backs up) video data.

Cameras transmit video data obtained by video servers through communication channels. Video servers perform analytical processing, storage and archiving of the video data received.

As a general rule, analytical processing of video data by a video server is reduced to detection of motion in the field of view of the camera. The video server determines the scope and intensity of motion in the frame.

In some cases, analytical processing of video data by the video server involves the use of video analytics. “Video analytics” typically involve computer vision methods for automated preparation of various data based on the sequence analysis of images incoming from cameras in real time or from archived records. Video analytics automate the four functions of video surveillance: detection, tracking, recognition and prediction. For example, some types of video analytics perform automatic recognition of the following alarms (objects and situations): a crowd of people (queue), a person crossing a signal line, fast movement (running) of a person or signs of fire.

Video analytics result in events, messages and/or metadata that can be delivered to users or archived for later analysis.

An “event” is the data obtained from one or more event sources when predetermined conditions are changed. The event sources include: a video surveillance system, a source video, video analytics, sensors or users. Events transmitted to the computer system through electronic communication channels can be recorded and archived (to a system log or protocol) and/or broadcast to users as messages.

A “message” typically involves the information of the video surveillance system event and may include one or more of the following: time and place of the event, type of the event, attributes of the object that initiated the event, metadata and video data which describes the event.

An alarm message can inform the user of the event posing a potential threat to security, such as a fire or equipment failure.

Information messages can inform the user of events occurring at the facility monitored, for example, the beginning of a particular technological process or a queue in front of a cash desk.

A “video archive” contains data stored on the video server and containing the surveillance system video codes, messages, events and metadata. Metadata can include a camera ID, a timestamp, the type of situation detected, coordinates, trajectory and classification of the object as well as detection accuracy evaluation.

A movement detector and video analytics may be embedded into the camera, thus reducing the load on the video server and the communication channels between the camera and the video server. Embedded analytics allow cameras to transmit not only video, but also messages, events and metadata, that is, the results of the video analysis.

The camera or video server may be connected to external sensors (e.g., smoke or door opening sensors) to generate events referring to the video data to be displayed to the user and archived.

The user workstation is connected to a video server on the network and allows the user to view streaming (live) video and video archives, as well as to receive alarms or information (notifications) on the situation at the monitored facility.

A standard user workstation is client software for a desktop computer with a standard operating system, such as Microsoft Windows.

Some modern video surveillance systems include user workstations for personal devices (mobile client), such as smartphones and tablet computers. A standard mobile client is client software for iOS, Android or Windows Mobile.

Mobile clients allow the user to remotely view live video from cameras and archived video recorded on a video server using wireless communication channels, such as GSM (Global System for Mobile Communications), LTE (Long Term Evolution) or Wi-Fi (Wireless Fidelity). In addition, some mobile clients allow controlling a PTZ camera (Pan, Tilt and Zoom) or transfer video from a cell phone camera to a video archive.

Unlike client software for desktop computers, mobile clients present an engineering challenge due to a number of limitations imposed by mobile devices: (a) limited and unstable bandwidth of the wireless links used to connect mobile devices to the network; (b) limited battery life of mobiles devices, (c) less powerful video playback hardware; (d) mobile device peculiarities, such as temporarily disabling the screen or sound, and (e) hardware and software compatibility issues between various mobile devices and operating systems.

Some modern video surveillance systems use cloud servers for failsafe video storage and transfer to mobile clients. This cloud surveillance system assumes that processing and storage of video data on virtualized computing resources are not limited by embodiment, physical configuration or geographic location of the video server hardware.

The use of servers on cloud or dedicated computers connected to the Internet makes it easier to connect mobile users to video servers located at the monitored facilities. Thus, using a server in a global network does not require a static IP-address with Network Address Translation (NAT) to connect mobile users to a video server through a local network.

Sources of events and related messages include video analytics, a variety of sensors and measuring devices, alarm buttons, touch screens and other technical means.

Event sources also include the users (operators) who generate the event based on the received image data, voice data (e.g., on the phone or door panel) and other signals that describe the state of the facility monitored.

CCTV functions include prompt messaging, i.e., live event message transfer to personal devices or mobile clients for immediate analysis.

Modem CCTV systems have the following disadvantages that hinder prompt messaging to mobile devices.

First, many video surveillance systems do not support prompt messaging to mobile devices in standby mode. Mobile clients of such surveillance systems can show messages (events) only on demand. In other words, the user has to open the mobile client regularly and check for new messages (events). In addition, the above mobile clients require a large quantity of system resources to maintain a communication session between the mobile client and the remote computer system, resulting in rapid discharge of the battery of the mobile device.

Second, some video surveillance systems use a service of short text messages (Short Message Service or SMS). This approach does not allow the user to perform prompt analysis of the alarming situation by viewing the video or image of the situation. The use of video analytics to generate alarm messages always carries a high level of risk of false alarms, and the video data associated with the alarm event are necessary for the user to make a decision on further action.

Third, some video surveillance systems use the Multimedia Messaging Service (MMS) to deliver alarm messages. The disadvantages of this approach include the high cost of each message, imposed by the mobile operator on the user (especially when in the roaming mode) and the limited size of the video data transmitted (typically 300 KB).

Fourth, some video surveillance systems use e-mail services to deliver alarm messages. The disadvantages of this approach include the lack of mechanisms to ensure timely delivery, time-consuming uploading of bulky email applications and the risk of missing an alarm message among other e-mail messages.

### SUMMARY OF THE INVENTION

The invention ensures prompt alarm notifications from the objects monitored to mobile devices, such as smartphones or tablet computers. The invention can be used in such industry sectors as safety and security, communications, transportation, retail, manufacture, sports, entertainment, housing and utility services and social infrastructure. The invention functions on local and global networks as well as dedicated and cloud-based servers, and can be built directly into a camera, video server, video recorder or mobile device as hardware and/or software.

The invention can be applied in a local corporate network to promptly deliver video-data messages to staff members' mobile devices via a Wi-Fi wireless network.

The invention can be applied in the global internet network to deliver alarm messages to remote users' mobile devices via GSM or LTE wireless networks.

In the underground transportation security system, the invention facilitates the delivery of alarm messages to a station operator and police officers to inform them about people and objects falling on rails. The video or picture received allows the authorised officials to promptly verify the alarm message and make a decision.

In retail and banking networks, the invention allows to inform a senior cashier of prospective or actual queues. The video or picture received allows the senior cashier to decide whether to open another cash desk or send an assistant to an operating desk.

The invention can be applied by housing and utility services to inform owners of apartments, cottages and cars of the possible theft or damage to property. In addition, the invention can inform parents that their children are coming home from school or monitor elderly people at home.

In manufacturing, the invention can be applied to monitor the manufacturing process and performance. For example, an enterprise manager will receive a video message to his mobile device in case of fire or smoke detection, unauthorised access to equipment or if a team fails to start or complete an operation in time.

The invention can be applied to guarding strategic facilities, with an authorized person receiving alarms with video data to mobile devices when someone enters a prohibited area or activates the fire alarm. The image on the mobile device allows a person to verify the alarm and take adequate measures.

The invention can be applied to sports and entertainment facilities when a visitor receives notifications containing a link to a commemorative video featuring this visitor (e.g., video of a descent down a ski slope or at the time of arrival to karting).

The invention can be applied in video surveillance systems based on the standards and/or recommendations of the Open Network Video Interface Forum (ONVIF, www.onvif.org), the Physical Security Interoperability Alliance (PSIA, psiaalliance.org) or the Common Alerting Protocol (CAP, http://docs.oasis-open.org/emergency/cap/).

The invention addresses the above disadvantages and increases the efficiency and convenience to the user when operating the mobile device surveillance system.

The technical result of the present invention is prompt surveillance event reporting from the video server to mobile devices with the ability to view the corresponding video data.

Unlike existing solutions, the invention facilitates the user's decision-making, reduces the response time to messages, increases the efficiency of wireless communication channels, reduces the power consumption of mobile devices as well as communication costs.

The invention facilitates video data delivery from a server to a mobile device in two stages: at the first stage, the server delivers a short message with the video data link to the mobile device. At the second stage, the mobile application downloads the video link from the received alarm message.

An important technical feature of the invention is that the separate transmission of an SMS message and a video allows a mobile device to download the video data from the server either upon request of the user or automatically upon detection of a fast and/or cost effective channel for connecting to the Internet. For example, a Wi-Fi connection is usually free (non-chargeable), while a GSM connection is not (chargeable).

Another important advantage is that in the event of multiple alarms, the user may select the link with the highest priority to download the video data based on the text message.

Some embodiments of the invention support message delivery from a local video server to a mobile device via a central server, that is, an additional Internet computer system. The central server supports routing, caching and logging messages, as well as routing and transcoding video data based on the available bandwidth of communication channels between the central server and mobile devices.

The advantage of delivering alarm messages through a central server is that the central server can continuously maintain multiple permanent connections between the central server and mobile devices without creating a burden on the video server or its outbound channel (uplink). As a result, the load on the video server and the uplink is not dependent upon the number of mobile clients in use.

The above embodiment of the invention facilitates alarm message transmission to multiple mobile devices. The message is sent from the video server to the central server only once through the limited bandwidth uplink, and is then delivered to all mobile devices through the channels of the central server with wide bandwidth, thus increasing the efficiency of the resources of the video server its uplink.

Another advantage of this embodiment of the invention is the increased reliability of alarm delivery to a mobile device. The central server can generate a message queue for mobile devices that are outside of the coverage area of a network and sends this queue through wide channels when the mobile device becomes accessible again. If the central server link is faster and more reliable than the local video server uplink, the delivery of notifications to the mobile device will be more reliable if transmitted via the central server rather than directly from the video server to the mobile device.

According to a first broad aspect of the present technology, there is provided a method of a transmission of a message according to the present invention consists of with several steps:
a) receiving at the first computer system an event and related data, the events and related data including video data and information on the video data, the video data and information on the video data including at least a link to the video data;
b) generating a message based on the event and the related data, the message including at least a link to the video data;
c) sending the message from the first computer system to the second computer system;
d) receiving the message on the second computer system;
e) performing an analysis of the message received;
f) if the analysis of the message received shows an analysis of the video data is required, downloading the video data from the link in the message.

According to another broad aspect of the present technology, there is provided a method of transmitting a message from a first computer system to a second computer system, taking into account the network connection fees, consists of the following steps:
a) receiving at the first computer system an event and related data, the event and related data including video data and information on the video data;
b) generating a message based on the event and the related data, the message including at least a link to the video data;
c) sending the message from the first computer system to the second computer system;
d) receiving the message on the second computer system;
e) determining available network connections to the Internet and their pricing;
f) if a free network connection is detected, downloading the video data from the link in the message using one of the free network connections detected;
g) if there are no free network connections detected, downloading the video data from the link in the message, using one of the chargeable connections detected, as determined by the user;

According to another broad aspect of the present technology, there is provided a system, the system, comprising:
a. the first computer system;
b. the second computer system;
c. wherein the first computer system includes:
   i. at least one first processor;
   ii. a first storage device;
   iii. at least one first set of programs;
   iv. wherein the at least one first set of programs is stored on the first storage device, the at least one first set of programs intended to be executed on at least one first processor, and includes instructions for:
      1. receiving the event and the related data;
      2. generating a message based on the event and the related data, the message including at least a link to video data received;
      3. sending the message to the second computer system.
d. wherein the second computer system includes:
   i. at least one second processor;
   ii. a second storage device;
   iii. a data display device;
   iv. at least one second set of programs;
   v. wherein the at least one second set of programs is stored on the second storage device, the at least one second set of programs intended to be executed on the at least one second processor, and includes instructions for:
      1. receiving the message;
      2. performing an analysis of the message received;
      3. if the analysis of the message received shows an analysis of the video data is required, downloading the video data from the link in the message.

The first computer system may include a network camera, a video server, a video recorder or a cloud server.

The second computer system may be implemented as: a personal portable device, a mobile phone, a smartphone, a tablet computer, a laptop computer, a desktop computer, a touch panel or a computer built into a building or vehicle at the workplace.

The source of the video data can be a video sensor, camera or video encoder.

The source of the video data can be a network video server, video recorder or video storage server. Such a video source can be a standard or special purpose computers with a disk or solid-state memory to store videos.

The source of the video data can be physically located locally at the monitored facility.

The source of the video data or remotely, for example, on a dedicated or cloud server on the Internet.

The source of the video data can be virtualized, i.e., the implementation it is not limited by the physical configuration or geographical location of the hardware.

The source of the video source can be fixed or mobile, including being embedded within a mobile phone.

The source of the video can prepare video data dynamically on demand from a mobile device. For example, having received a request from mobile device, the server uploads the video data from the storage and writes the video data to a file transmitted to the mobile device.

Messages and/or video data may contain results with video analytics, including the location, trajectory, signs, classification and identifiers of the objects recognized by the video analytics.

Messages and/or video data may contain results of the monitoring of the quality of the video signals from the video camera. For example, an alarm message can be transmitted in the event of loss of connection to the camera, as well as in case of a blackout, light exposure, focus shift or noise masking of the video data received from the camera.

Messages and/or video data may comprise data about the alarm source, including the spatial coordinates of the camera, a map fragment, a map link or a text name specified by the user.

Messages and/or video data may contain telemetry data on the state of the sensors and actuators connected to the surveillance system, e.g., smoke, temperature or door opening sensors.

A message can be transmitted in accordance with the interface specifications of the ONVIF, PSIA or CAP, with a link to the video data included in one of the alarm message fields.

A message may contain several links to different portions of the video data. For example, one link can point to a single frame of the alarm object for rapid analysis of the situation, and a second link can point to the full video of the alarm object for the detailed analysis of the situation.

A message may contain several links to video data of different quality and bit rates.

A message may contain an identifier of the user (operator) initiating the message and the corresponding event.

A link to the video data contained in the alarm message can be specified in the URI (Uniform Resource Identifier) format. For example, the link “http://myserver.com/video/stream.ts” leads to the protocol type “http://”, the name of the server “myserver.com”, the path and file name of the video data “/video/stream.ts”.

A link to the video data contained in the alarm message can be specified in the form of an arbitrary character ID, number, time stamp or composite identifier. For example, if the event occurred after 5 minutes and 10 seconds from the beginning of recording the video data to a file, the reference “http://myserver.com/video/stream.ts?time=5m10s” can request video data with the corresponding time delay.

The video data may contain one or more frames as well as one or more fragments of frames.

The video data can be transmitted in the form of video streamed in real time from a video source or from storage at a the local video server or a central server. For streaming live video, standard streaming video protocols such as RTSP (Real Time Streaming Protocol), RTMP (Real Time Messaging Protocol), HLS (HTTP Live Streaming) and DASH (Dynamic Adaptive Streaming over HTTP) can be used. The speed and quality of the video transmitted can automatically adapt to the communication channel of the mobile device.

Video data can be transmitted in compressed form, for example, using H.264, VP8, MJPEG, JPEG, JPEG2000 encoders.

Video data can be transmitted as separate files using standard containers, for example, WebM, OGV, MKV, MP4, TS, JPG, etc.

Video data can be transmitted over wireless networks such as GSM (Global System for Mobile Communications), CDMA (Code division multiple access), LTE (Long Term Evolution) and Wi-Fi (Wireless Fidelity). In some embodiments of the present invention, receiving and/or sending data is carried out using several technologies described above or transmission/reception technologies to be invented following submission of the application for the present invention.

A message with a link to video data can be transferred using push-technology, for example, based on XMPP/Jabber, Apple Push Notification service (APNs) and Android Cloud to Device Messaging (C2DM) protocols. This delivery method is advantageous when the mobile device is within the home cellular network and the cost of data transmission is not high for the user.

A message with a link to the video data can be transmitted via SMS. This approach is advantageous when the mobile device is in roaming mode and the cost of data transmission is high for the user. Moreover, this approach can be used when data service is not available in the mobile network or the mobile device is turned off. Some operating systems for mobile phones, for example, Android, support intercepting SMS messages and processing them in a mobile client video surveillance system.

The server can select the optimal delivery method for alarm messages with a link to the video data on the basis of one or more criteria, such as the availability of a connection to the mobile device for push-notification, personal user settings, a user's rate plan, the geographic location of the mobile device and the time of the day/week.

A mobile device can automatically download video from a video source.

A mobile device can download video from the video source on demand of the user.

A mobile device can store the downloaded video data in the built-in memory of the mobile device and/or display it on the screen.

A mobile device can emit a sound and/or light signal following receipt of new alarm messages and/or downloading the video data.

The server can be a separate physical (designated) computer or a virtual computer, i.e., alarm messages can be transmitted through virtualized computing resources, not limited to the implementation of a physical configuration or by the geographic location of the hardware. In particular, the server may comprise several computers connected to a single cloud server.

The server and the video data source can be merged into a single piece of hardware and/or software.

A message according to the present invention can be used not onto to inform a user of alarms, but also that to inform the user of any other events, such as the availability of video data for viewing and the completion of the video data recording process.

### BRIEF DESCRIPTION OF DRAWINGS

FIG. 1. depicts an embodiment of a system for implementing the method of prompt transmission of messages with video data in which the video data is transmitted from a local video server to a mobile device via a central server.

FIG. 2. depicts a signal flow diagram illustrating interactions of the various components of the system of FIG. 1.

FIG. 3. depicts another system for implementing the method of transmission of messages with video data in which the video data is transmitted from the local video server directly to the mobile device.

FIG. 4. depicts a signal flow diagram illustrating interactions of the various components of the system of FIG. 3.

FIG. 5. depicts an illustration of a central server for the transmission of alarm messages to mobile devices.

FIG. 6. depicts a schematic diagram of a user interface of a mobile application to receive alarm notifications with video data.

FIG. 7 depicts a user interface of a mobile application implemented in accordance with some embodiments of the present technology.

FIG. 8 depicts a user interface of a mobile application implemented in accordance with other embodiments of the present technology.

FIG. 9 depicts a user interface of a mobile application implemented in accordance with yet additional embodiments of the present technology.

FIG. 10 depicts a user interface of a mobile application implemented in accordance with yet other additional embodiments of the present technology.

### EMBODIMENTS OF THE INVENTION

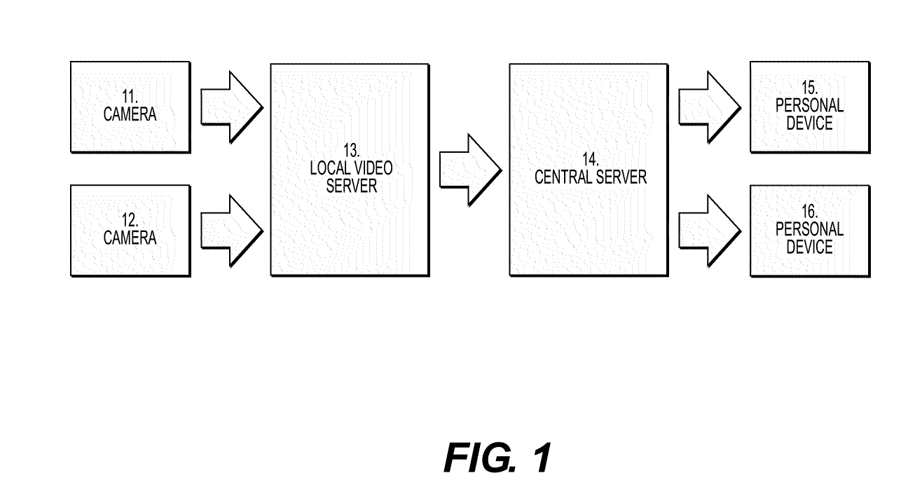

FIG. 1 shows a system for implementing the method of prompt transmission of messages with video data in which the video data is transmitted from a local video server to a mobile device via a central server.

The first computer system includes local video server 13, which can be located at the monitored premises, and central server 14, which can be located on a dedicated or cloud server on the Internet.

The second computer system comprises mobile devices 15-16.

Several cameras 11, 12 transmit video data to the video server 13 through the local network. The local video server processes the video data with the use of video analysis algorithms and generates reports based on the results of the video analysis. In the event of an alarm, the local video server sends the corresponding message and video data to the central server 14. The central server 14 can be connected to local video servers located at various CCTV sites. The central server 14 sends the alarm message without video data to the mobile devices 15-16. Mobile devices with access to communication channels of sufficient bandwidth download video data from the central server to be displayed to the user. The server sending alarm messages and the source of the video data are merged into the central server 14.

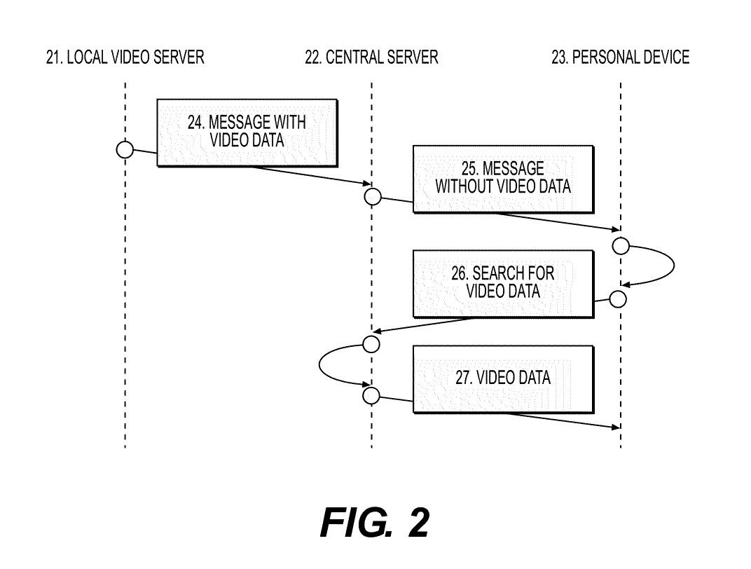

FIG. 2 shows a diagram of interactions of the method of prompt transmission of messages with video data of FIG. 1. Local server 21 sends an alarm message with video data 24 to central video server 22. Then, the central video server 22 transmits an alarm message without video data 25 to mobile device 23. Next, the mobile device 23 sends a request with a link to the video data 26 to the central video server 22. After this, the central server 22 sends requested video data 27 to the mobile device 23.

The scheme of the implementation of the method described in FIGS. 1-2, demonstrates the technical result of the invention, which consists of transmitting an alarm message with video data to a mobile device.

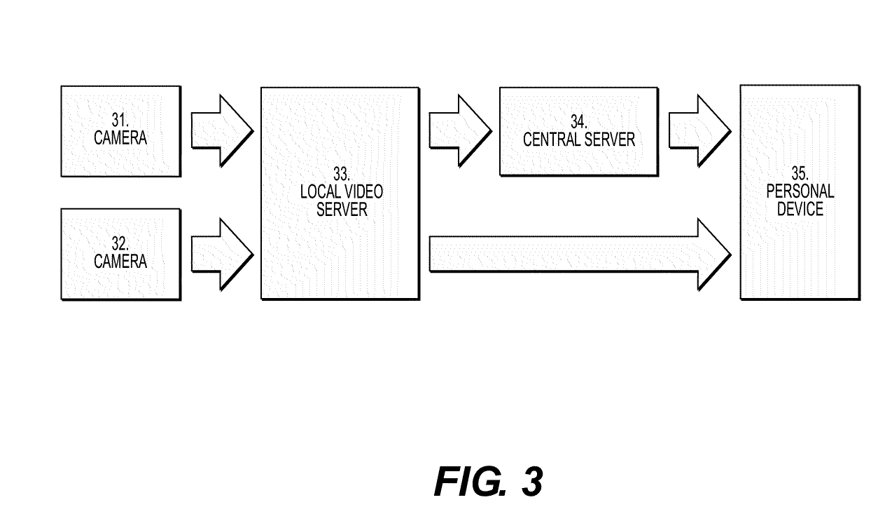

FIG. 3 shows a system for implementing the method of transmitting prompt messages with video data in which the video data is transmitted from the local video server directly to the mobile device.

The first computer system includes local video server 33, which can be located at monitored premises, and central server 34, which can be located on a dedicated or cloud server on the Internet.

The second computer system comprises mobile device 35.

Several cameras 31, 32 transmit video data to the local video server 33 over the local network. The local video server processes the video data with the use of video analysis algorithms and generates reports based on the results of the video analysis. In the event of an alarm, the local video server sends the corresponding message without video data to the central server 34. The central server 34 can be connected to local video servers located at various CCTV sites. The central server 34 sends the alarm message without video data to the mobile device 35. Mobile devices with access to communication channels of sufficient bandwidth download video data from the central server 33 to be displayed to the user. In this scheme for implementing the invention, the central server performs the alarm transmission function, while local server 33 is the source of the video data.

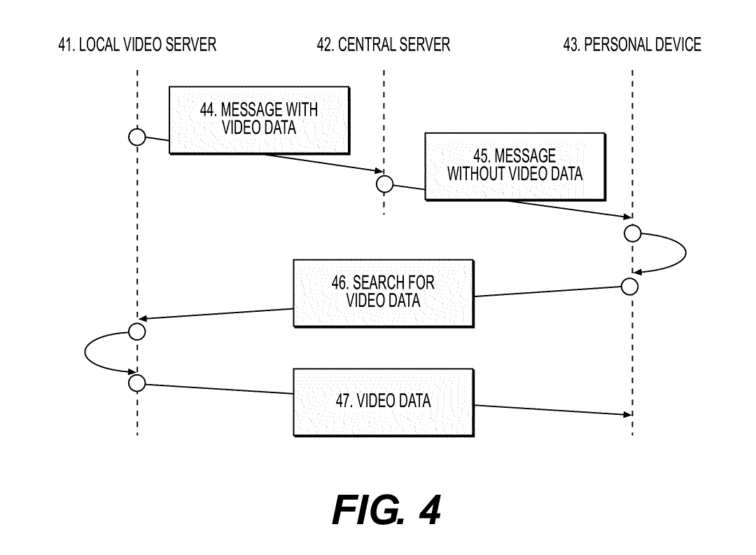

FIG. 4 shows a diagram of interactions of the method of prompt transmission of messages with video data of FIG. 3. Local video server 41 sends an alarm message without video data 44 to central video server 42. Then, central video server 42 transmits the alarm message without video data 44 to mobile device 43. Next, mobile device 43 sends a request with a link to video data 46 to the local video server 41. Next, local video server 41 sends the requested image data 47 to mobile device 43.

The scheme of implementation of the method described in FIGS. 3-4, demonstrates the technical result of the invention, which is transmitting an alarm message with video data to a mobile device.

In comparison with the scheme in FIGS. 1-2, the scheme in FIGS. 3-4 generated less load on the central server, but more load on the local video server and its connection channels. The scheme of FIGS. 1-2 is preferred if the same alarm message is delivered to several mobile devices at the same time, and the users are willing to pay the cost associated with the additional load on the central server.

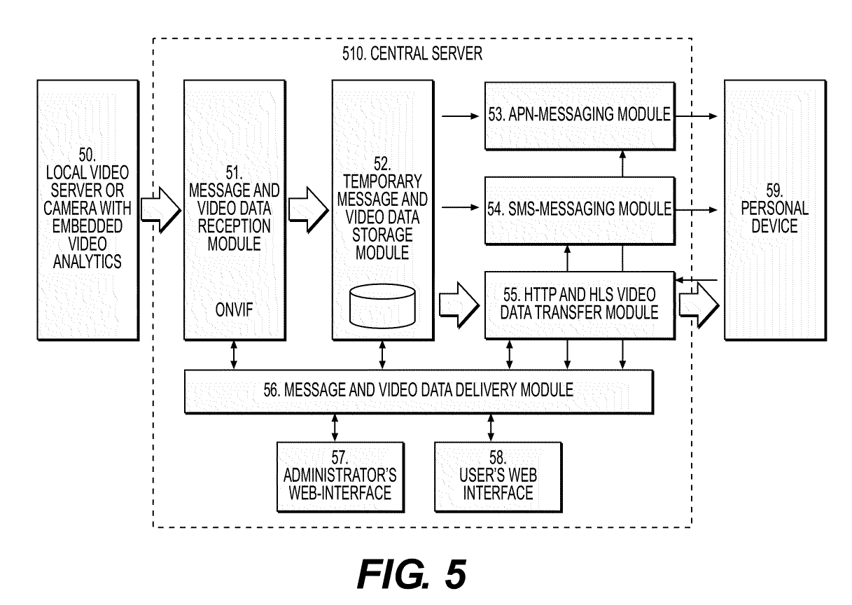

FIG. 5 depicts another system implementing a central server 51 for the transmission of alarm messages by local server 50 to mobile device 59, in accordance with one of the possible implementations described in FIGS. 1-2.

A new alarm message with video data is received from a local server or a camera with embedded video analytics 50 to message and video reception module 51 via the ONVIF protocol. The module 51 can implement the Network Video Client (NVS) interface or the ONVIF interface, and the local server implements the Network Video Transmitter (NVT) interface or the Network Video Analytics (NVA) interface.

The new alarm message and video data are temporarily stored in module 52. Messages can be automatically removed from module 52 after delivery of the message to all addressable mobile devices or upon expiration of expectancy thereof.

The new alarm message arrives at the module for transmission to the mobile device via the APN service 53. If delivery via APN is not possible, for example, because the mobile device does not have a data delivery connection, the new message is delivered via the SMS service 54. Delivery via SMS can be more expensive for the central server operator than delivery via APN, but less expensive for the mobile device user.

Mobile device 59 downloads the video from the link in the alarm message through module 55 at the time the data connection becomes available and/or upon demand by the user.

The module 55 implements an HTTP (Hypertext Transport Protocol) server for sending files (such as JPG frames or MP4 video), as well as an HLS (HTTP Live Streaming) server for live video transmission to a mobile device. The video data delivery protocol is selected depending on user settings, the type of communication channel and the availability of roaming.

Module 56 controls the operation of all the modules, generates alarm mailing lists, connects/disconnects mobile devices and controls the size of the stored messages and video data.

The module 56 has a web-based user interface 58 and an administrator user interface 57 to configure the control functions.

The central server can be run on a dedicated or cloud server, for example, Amazon EC3 cloud hosting.

The software of the central server can be implemented in C #, Java, PHP and Python. Messages are stored in a relational database (e.g., MySQL or PostgreSQL) or an object-oriented database (e.g., db4o). Video is stored in standard or specialized file systems.

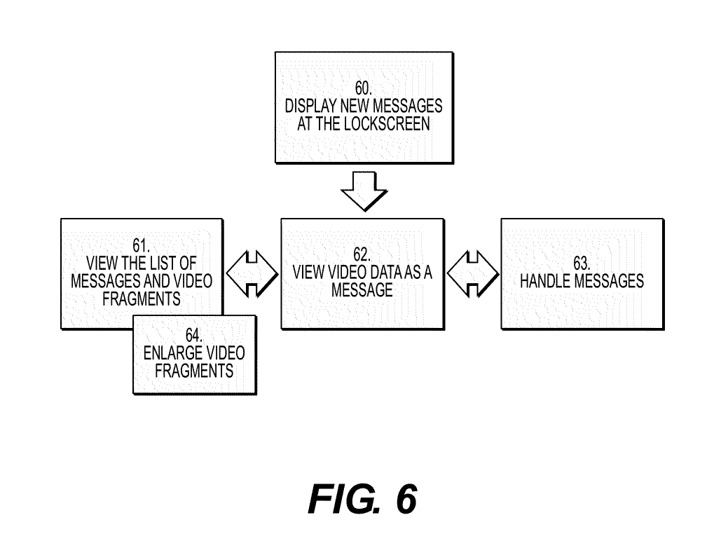

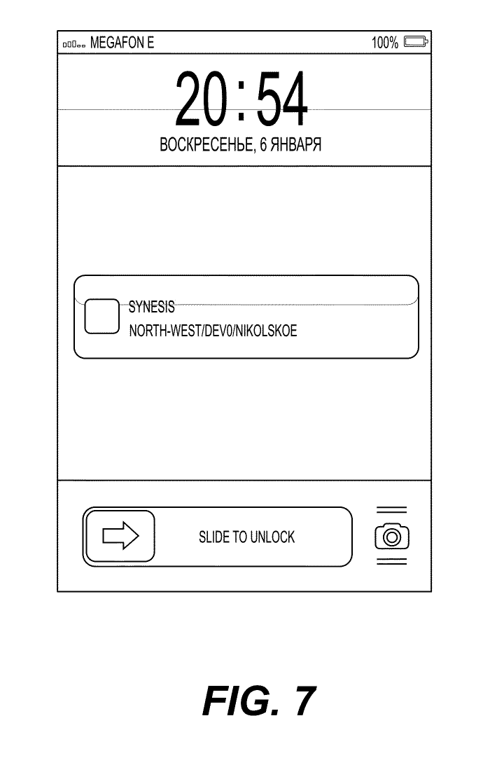

FIG. 6 shows another schematic diagram of a user interface of a mobile application to receive alarm notifications with video data on the iOS operating system. Form 60 displays the time of receipt of a push notification for a new alarm message from the central server via the APN service. If the APN service is not available, the alarm message can be sent by SMS. An example of a user interface implementing the form 60 is depicted in FIG. 7.

If the user opens the message with their finger, the mobile device loads one image of the video data from the central server via the first link in the received alarm message. Frame transmission is carried out in the JPEG format via the HTTP protocol. The frame is displayed on the form for viewing the video data 62, with the alarm object that caused the alarm situation being framed.

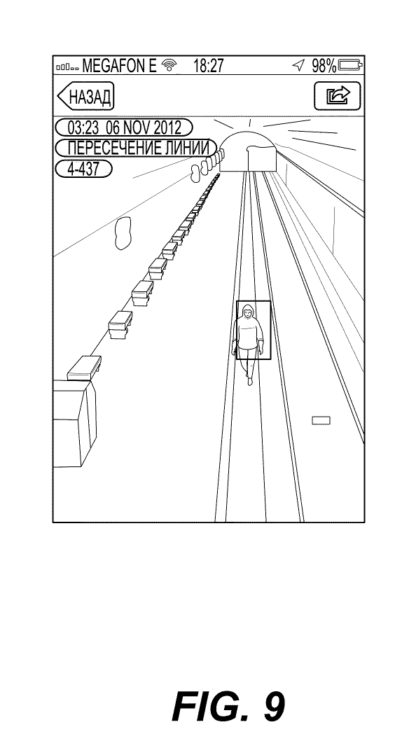

An example of a user interface implementing the form 62 is depicted in FIG. 9.

A graphical abstract of the alarm conditions, such as a frame separating the cause of the event, can be sent either in the XML format, or together with the video data.

When the alarm frame is selected, the mobile device requests the central server video for a stream from the second link in the alarm message. The central server sends streaming video to the mobile device via HLS.

Video data can be transmitted not only as an HLS stream, but also as a file, for example, in the MP4 format.

Form 64 allows to export video data, such as via e-mail or through the MMS service, and call an emergency rescue service (the red button numbered 112).Form 61 can be used to view the list of messages or to Form 62 to handle the message.

Form 61 shows a list of alarms received in the form of alarm frame fragments. Clicking on a fragment of the frame, the user is presented with Form 62.

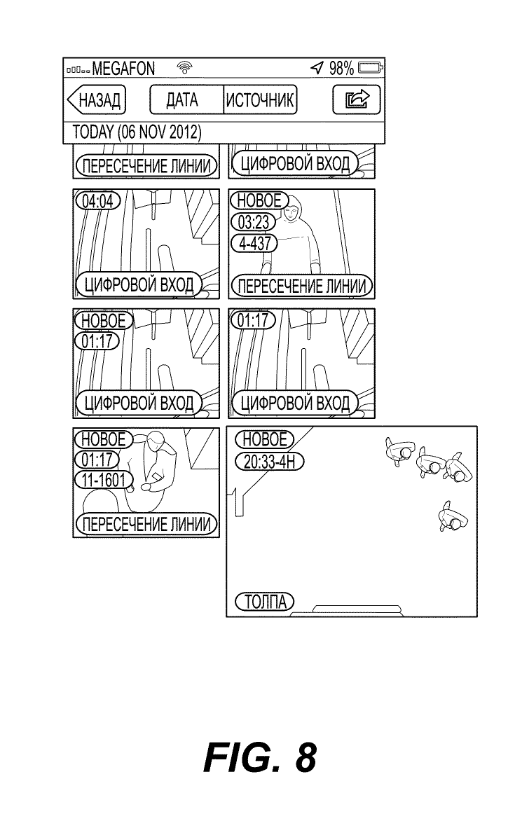

An example of a user interface implementing Form 61 is depicted in FIG. 8.

Form 64 allows to export video data, for example, by e-mail or MMS, and call the emergency rescue service (the red button numbered 112).

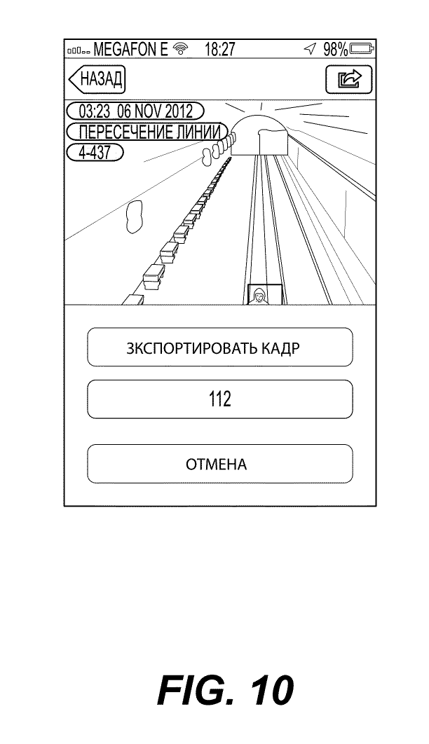

An example of a user interface implementing Form 63 is depicted in FIG. 10.

Form 64 enlarges the portion of the video data (alarm frame). An example of a user interface implementing Form 64 is depicted in FIG. 8.

Element 71 is one possible implementation of the form 61.

Element 72 is one possible implementation of the form 62.

Element 73 is one possible implementation of the form 63.

Element 74 is one possible implementation of the form 64.

Thus, the above described system of implementation of the user interface allows to send an alarm message to a mobile device, even if the latter is in standby or roaming mode, with the data connection disabled. In this case, the event-related video data is transferred from the alarm message link at the user's request. The separate use of the two links to the alarm frame and the video stream minimizes the amount of video data sent to the mobile device and reduces the average time of decision-making. Most of the decisions can be made by the user based on the analysis of a single frame without viewing the full video of the event.

In addition, a link to a single frame allows to receive image files for generating thumbnail image of alarm messages, as shown in the Form 61.

Although the present invention has been described as an example embodiment thereof, this description is not limiting and is only provided for illustration and for better understanding of the invention, the scope of which is defined by the claims below.

1. A method of transmitting a message from a first computer system to a second computer system, the method comprising:
a) receiving at the first computer system an event and related data, the event and related data including video data and information on the video data;
b) generating a message based on the event and the related data, the message including at least a link to the video data;
c) sending the message from the first computer system to the second computer system;
d) receiving the message on the second computer system;
e) performing an analysis of the message received;
f) if the analysis of the message received shows an analysis of the video data is required, downloading the video data from the link in the message.

2. A method of transmitting a message from a first computer system to a second computer system, the method comprising:
a) receiving at the first computer system an event and related data, the event and related data including video data and information on the video data;
b) generating a message based on the event and the related data, the message including at least a link to the video data;
c) sending the message from the first computer system to the second computer system;
d) receiving the message on the second computer system;
e) determining available network connections to the Internet and their pricing;
f) if a free network connection is detected, downloading the video data from the link in the message using one of the free network connections detected;
g) if there are no free network connections detected, downloading the video data from the link in the message, using one of the chargeable connections detected, as determined by the user.

3. A system comprising:
a) a first computer system;
b) a second computer system;
c) wherein the first computer system includes:
i. at least one first processor;
ii. a first storage device;
iii. at least one first set of programs;
iv. wherein the at least one first set of programs is stored on the first storage device, the at least one first set of programs intended to be executed on at least one first processor, and includes instructions for:
1. receiving the event and the related data;
2. generating a message based on the event and the related data, the message including at least a link to video data received;
3. sending the message to the second computer system.
d) wherein the second computer system includes:
i. at least one second processor;
ii. a second storage device;
iii. a data display device;
iv. at least one second set of programs;
v. wherein the at least one second set of programs is stored on the second storage device, the at least one second set of programs intended to be executed on the at least one second processor, and includes instructions for:
1. receiving the message;
2. performing an analysis of the message received;
3. if the analysis of the message received shows an analysis of the video data is required, downloading the video data from the link in the message.

4. The method of claim 1, wherein the second computer system is a telephone.

5. The method of claim 1, wherein the second computer system is a mobile phone.

6. The method of claim 1, wherein the second computer system is a smartphone.

7. The method of claim 1, wherein the second computer system is a tablet computer.

8. The method of claim 1, wherein the video data comprises at least one of: audio data, text and technical information about the video data parameters.

9. The method of claim 1, wherein the second computer system is a desktop computer system.

10. The method of claim 1, wherein the message contains data associated with the event, the data including at least one of the following parameters:
a. metadata;
b. video source identifier;
c. event source identifier;
d. timestamp;
e. spatial coordinates of the object;
f. object trajectory;
g. object classification;
h. object detection accuracy assessment;
i. spatial coordinates of the camera;
j. fragment of a map;
k. link to a map;
l. text name specified by the user,
m. telemetry data received from a smoke sensor;
n. telemetry data received from a gas sensor;
o. telemetry data received from a temperature sensor;
p. telemetry data received from the door sensors;
q. signals received from emergency buttons;
r. data received from the sensors;
s. video quality monitoring results.

11. The method of claim 1, wherein the video data related to the event is stored in cloud storage.

12. The method of claim 1, wherein the video data related to the event is stored on a dedicated server.

13. The method of claim 1, wherein the video data related to the event is stored on a distributed computer system.

14. The method of claim 1, wherein the video data related to the event is stored on the first computer system.

15. The method of claim 1, wherein the message is sent in accordance with the ONVIF, PSIA or CAP interface specifications, and the link to the video data is in one of the message fields.

16. The method of claim 1, wherein the message contains at least two links to different portions of the video data.

17. The method of claim 1, wherein the message contains a portion of the video data and a link to the video data.

18. The method of claim 1, wherein the message contains a link to a portion of the video data and a link to the video data, and the second computer system, after receiving the message, automatically loads a portion of the video data from the link.

19. The method of claim 1, wherein the link to the received video data is generated in the Uniform Resource Identifier (URI) format.

20. The method of claim 1, wherein the link to the video data is set as one or a combination of the following parameters:
a. arbitrary character identifier
b. number
c. timestamp
d. portion identifier.

21. The method of claim 1, wherein the link in the message points to streaming video data.

22. The method of claim 1, wherein the link in the message points to video data stream transmitted in real time.

23. The method of claim 1, wherein the link in the message points to compressed video data.

24. The method of claim 1, wherein the link in the message points to video data stored in separate files.

25. The method of claim 1, wherein the message contains at least one link to video data of different video quality and bit rate.

26. The method of claim 1, wherein the video data is received on the second computer system via a wireless network.

27. The method of claim 1, wherein the transmission of the message is implemented on the basis of push-notification technology.

28. The method of claim 1, wherein the transmission of the message is implemented on the basis of SMS technology.

29. The method of claim 1, wherein the second computer system loads the video data automatically from a video data source in the link.

30. The method of claim 1, wherein the second computer system downloads the video data from a video source in the link at a user's request.

31. The system of claim 3, wherein the second computer system loads and stores the video data in the second storage device.

32. The system of claim 3, wherein the second computer system further comprises means for supplying an audio signal, and at least one second set of programs further comprises instructions for supplying at least one of an audio and visual signal after at least one of a receipt of new alarm messages and downloading the video data.

33. A method of receiving a message, the method implemented at a computer system, the method comprising:
a) receiving from a local computer system, the local computer system being remote from the computer system the message, the message having been generated by the local computer system by:
receiving an event and related data, the event and related data including video data and information on the video data;
generating a message based on the event and the related data, the message including at least a link to the video data and excluding video data;
b) in response to receipt of a trigger, downloading the video data from the link in the message.

34. The method of claim 33, wherein the trigger comprises a user confirmation.

35. The method of claim 33, wherein the trigger is generated by the computer system by executing the steps of:
determining available network connections to the Internet and their associated parameters;
in response to a incremental-cost-free network connection being available, downloading the video data from the link in the message using incremental-cost-free network connection;
in response to no incremental-cost-free network connection being available, downloading the video data from the link in the message, using one of connection-fee-bearable connections detected.
